(19) United States
(12) Patent Application Publication
(10) Pub. No.: US 2004/0133443 A1
(43) Pub. Date: Jul. 8, 2004

(54) Method and apparatus for resolving an un-coded address

(76) Inventors: David J. Payne, Collierville (TN); Robert F. Snapp, Memphis, TN (US); James D. Wilson, Collierville, TN (US)

Correspondence Address: Finnegan, Henderson, Farabow,, Garrett & Dunner, L.L.P., 1300 I Street, N.W., Washington, DC, 20005-3315, US

(21) Appl. No.: 10/665,323

(22) Filed: Sep. 18, 2003

Related U.S. Application Data
(60) Provisional application No. 60/412,029, filed on Sep. 20, 2002.

(51) Int. Cl. G06F 17/60

(52) U.S. Cl. 705/1

(57) ABSTRACT

Resolving an un-coded address may comprise saving a resolved address. The address may be resolved by at least one of a plurality of address resolution processes. The resolved address may include a correct address record and an incorrect address record. Next, resolving an un-coded address may comprise receiving a first unresolved address and then determining if the first unresolved address matches the incorrect address record of the resolved address. Then resolving an un-coded address may comprise providing the correct address record if the first unresolved address matches the incorrect address record.

### RELATED APPLICATIONS

Under provisions of 35 U.S.C. § 119(e), Applicants claim the benefit of U.S. provisional application No. 60/412,029, filed Sep. 20, 2002, which is incorporated herein by reference.

### TECHNICAL FIELD

The present invention relates to the field of resolving data. More particularly, the present invention, in various specific embodiments, involves methods and systems for resolving an un-coded address.

### BACKGROUND

The United States Postal Service (USPS) is an independent government agency that provides mail delivery and other services to the public. The USPS is widely recognized as a safe and reliable means for sending and receiving mail and other items. With the advent and steady growth of electronic mail and electronic commerce, the physical mail stream will increasingly be utilized for sending and receiving packages. In the context of item delivery, a delivery system operator may desire, for example, to correct incorrect delivery address data. In addition, the delivery system operator may wish to correct or add codes to items to aid in item delivery.

Therefore, the need to efficiently provide corrected delivery address data has become a common need for the United States Postal Service and many other organizations. More specifically, efficiently resolving un-coded delivery address data has become a critical service for many delivery system operators. This is because in an increasingly competitive environment, meeting and exceeding the expectations of those who receive a service is essential for a service provider.

One solution, for example, to the corrected delivery address data problem is for the item delivery system operator to send the incorrect address through a plurality of different processes. In this situation, the item delivery system operator sends the address through the plurality of different processes each and every time the incorrect address is encountered. Even if the address had been corrected on a previous item sent through the item delivery system, the incorrect address would need to be sent through the plurality of processes the next time it is encountered on an item.

Great inefficiencies are created in this procedure because, for example, running the aforementioned processes can be very costly and time consuming. Accordingly, efficiently providing corrected delivery address data remains an elusive goal. Thus, there remains a need for efficiently providing corrected delivery address data. In addition, there remains a need for efficiently resolving un-coded addresses.

### SUMMARY OF THE INVENTION

Consistent with the current invention, resolving an un-coded address method and system are provided that avoid the problems associated with prior resolving un-coded address methods and systems as discussed herein above.

In one aspect, a method for resolving an un-coded address comprises saving a resolved address, the address being resolved by at least one of a plurality of address resolution processes, the resolved address including a correct address record and an incorrect address record, receiving a first address, determining if the first address matches the incorrect address record of the resolved address, and providing the correct address record if the first address matches the incorrect address record.

In another aspect, a system for resolving an un-coded address comprises a component for saving a resolved address, the address being resolved by at least one of a plurality of address resolution processes, the resolved address including a correct address record and an incorrect address record, a component for receiving a first address, a component for determining if the first address matches the incorrect address record of the resolved address, and a component for providing the correct address record if the first address matches the incorrect address record.

In yet another aspect, a computer-readable medium on which is stored a set of instructions for resolving an un-coded address, which when executed perform stages comprising saving a resolved address, the address being resolved by at least one of a plurality of address resolution processes, the resolved address including a correct address record and an incorrect address record, receiving a first address, determining if the first address matches the incorrect address record of the resolved address, and providing the correct address record if the first address matches the incorrect address record.

In yet another aspect, a system for resolving an un-coded address comprises means for saving a resolved address, the address being resolved by at least one of a plurality of address resolution processes, the resolved address including a correct address record and an incorrect address record, means for receiving a first address, means for determining if the first address matches the incorrect address record of the resolved address, and means for providing the correct address record if the first address matches the incorrect address record.

Both the foregoing general description and the following detailed description are exemplary and are intended to provide further explanation of the invention as claimed.

### BRIEF DESCRIPTION OF THE DRAWINGS

The accompanying drawings provide a further understanding of the invention and, together with the detailed description, explain the principles of the invention. In the drawings:

FIG. 1 is a functional block diagram of an exemplary item delivery system including an exemplary system for resolving an un-coded address consistent with an embodiment of the present invention;

FIG. 2 is a functional block diagram of an exemplary system for resolving an un-coded address consistent with an embodiment of the present invention;

FIG. 3 is a functional block diagram of an exemplary system for resolving an un-coded address consistent with an embodiment of the present invention;

FIG. 4 is a flow chart of an exemplary method for resolving an un-coded address consistent with an embodiment of the present invention; and

FIG. 5 is a functional block diagram illustrating a plurality of different address resolution processes consistent with an embodiment of the present invention.

### DETAILED DESCRIPTION

Reference will now be made to various embodiments according to this invention, examples of which are shown in the accompanying drawings and will be obvious from the description of the invention. In the drawings, the same reference numbers represent the same or similar elements in the different drawings whenever possible.

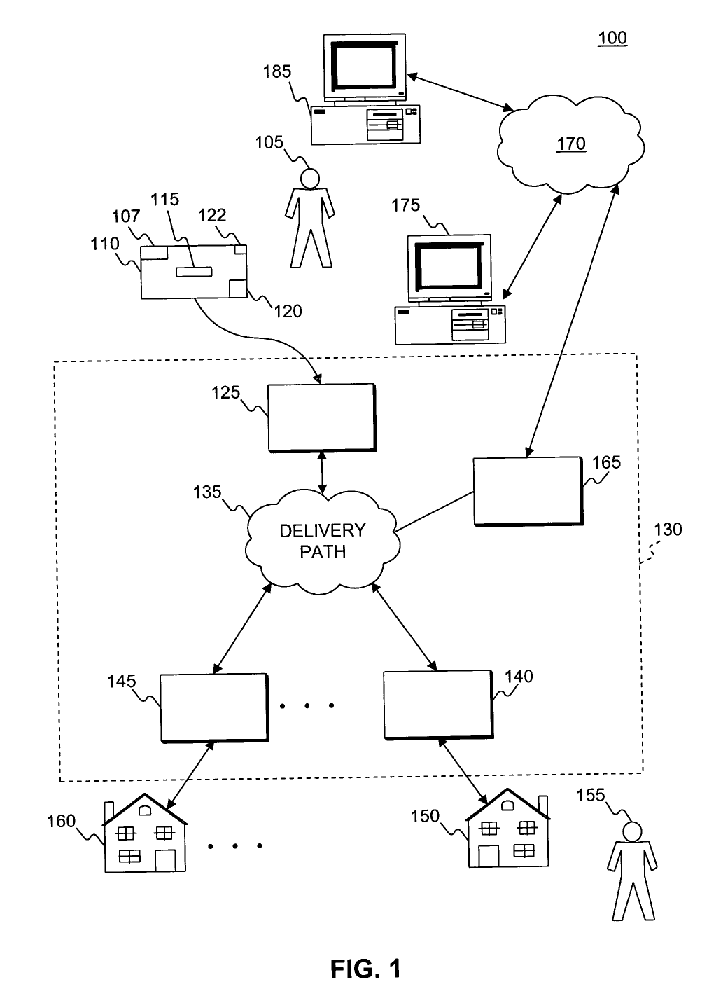

Consistent with an embodiment of the present invention, a system for resolving an un-coded address may comprise a component for saving a resolved address, a component for receiving a first address, a component for determining, and a component for providing. Consistent with an embodiment of the present invention and referring to FIG. 1, the aforementioned components may be included in a mailing system 100 which may comprise a resolving system 185 used in conjunction with a delivery system 130 and a user device 175. The aforementioned devices and systems are exemplary and other devices and systems may comprise the aforementioned components and still be consistent with embodiment of the present invention. In addition, resolving system 185 may be operated by an item delivery system operator or other entities or enterprises, for example.

Mailing system 100 is shown in FIG. 1. For example, a sender 105 may place an item 110 into delivery system 130. Item 110 may contain a label 115 indicating a first address 150 of a recipient 155 and a return address 107 indicating where to return item 110 if necessary. Item 110 may also contain a tracking indicia 120 relating sender 105 and recipient 155. Tracking indicia 120 may be placed on item 110 by sender 105 or the delivery system operator. In addition, item 110 may include a delivery payment coding 122 that will be described in greater detail below. Elements of and data contained in return address 107, label 115, tracking indicia 120, and delivery payment coding 122 may be included together as one element or label, for example, on item 110.

Item 110 may be routed through delivery system 130, which may comprise a sender plant 125, a delivery path 135, a first address plant 140, an alternative address plant 145, and an alternative processing point 165. Delivery path 135 may comprise a plurality of plants similar to sender plant 125, first address plant 140, and alternative address plant 145. The plants within delivery path 135 may contain, among other things, automated systems and sorting equipment and are designed to receive and process a plurality of items. Delivery system 130 may be configured to sense tracking indicia 120 or delivery payment coding 122 placed on item 110 as it passes through the elements of delivery system 130 directing the movement of item 110 through delivery system 130. In addition to facilitating the tracking of item 110 through delivery system 130, tracking indicia 120 and delivery payment coding 122 may identify a sales transaction and relate recipient 155 and sender 105.

Item 110 may comprise at least one of a mailpiece, a United States Postal Service Priority Mail package, a United States Postal Service Express Mail Package, a United States Postal Service Global Express Mail Package, or a United States Postal Service Global Express Guarantee Package. Moreover, item delivery system 130 a comprise elements of the United States Postal Service.

Tracking indicia 120 and delivery payment coding 122 may comprise a bar code or a PLANET code, for example, but may also comprise any machine-readable or optically-scanable element. A bar code is a printed code used for recognition by a bar code scanner (reader). Traditional one-dimensional bar codes use the bar's width to encode a product or account number. Two-dimensional bar codes, such as PDF417, MAXICODE and DATAMATRIX, are scanned horizontally and vertically and hold considerably more data. Generally, PDF417 is widely used for general purposes, MAXICODE is used for high-speed sorting, and DATAMATRIX is used for marking small parts.

Historically, system operators sorted flat mail using POSTNET, a 12-digit barcode consisting of alternating long and short bars indicating the destination of, for example, a mailpiece. Responding to the expanding needs of users, particularly heavy volume users, PLANET code was developed on the foundation of the existing technical infrastructure. The PLANET Code is the “opposite” of the current POSTNET codes, that is, reversing long bars for short and short bars for long. This innovation offers the convenience of a bar code that is easily applied using current bar-coding methods, and is readily scanned by the high-speed automation equipment already located in the plurality of plants comprising delivery system 130.

Item 110 may be sent through delivery system 130 by sender 105 to first address plant 140. At anytime in the delivery process a determination may be made as to whether item 110 is undeliverable. If it is determined that item 110 is undeliverable, item 110 may be forwarded to alternative processing point 165 where an ancillary service may be performed. Examples of such ancillary services are recycle service (treating item 110 as waste), NIXIE service, and Computerized Forwarding Service (CFS).

With respect to NIXIE service, NIXIE is a classification given to an item that cannot be sorted or is undeliverable-as-addressed because of an incorrect, illegible, or insufficient delivery address. If item 110 is undeliverable-as-addressed, address correction service (re-label with a correct address) or return service (return item to the sender) may be performed. In this case, a NIXIE operator specialized in the handling of such items is required. If item 110 requires return service, return address 107 on item 110 is read and item 110 is sent to return address 107 accordingly. Return address 107 is an element of item 110 that is usually placed in the upper left corner of item 110 to indicate the address of sender 105. This address indicates where sender 105 wants item 110 returned if it is undeliverable. In addition return address 107 may indicate where sender 105 will receive a bill for any fees due for the return of item 110. When item 110 requires address correction service, a NIXIE operator obtains the proper address of recipient 155 or the reason for non-delivery. While NIXIE processing may comprise address correction service or return service, those skilled in the art will appreciate that may other types of NIXIE processing may be performed.

Computerized forwarding service is a centralized, computerized address label-generating operation that forwards undeliverable-as-addressed items to recipients. In this case, recipient 155 may pre-register an alternative address 160 of recipient 155 with the delivery system operator in order to have all items forwarded to alternative address 160. For example, if recipient 155 moves and wishes to have items sent to alternative address 160, recipient 155 notifies the delivery system operator of alternative address 160. Once the delivery system operator is notified of alternative address 160, all items sent to first address 150 are detected by delivery system 130, re-labeled, and then forwarded to alternative address 160. In the aforementioned computerized forwarding service, items may be forwarded only for a specific period of time. The delivery system operator may expect recipient 155 to contact each and every sender who recipient 155 may expect to receive an item and notify the possible senders of the address change of recipient 155. After the computerized forwarding service time period is complete, the delivery system operator may cease forwarding items to recipient 155 and may return to the sender 105 all items sent to first address 150.

If ancillary services were required, item 110 may remain at alternative processing point 165 or may be processed at an item recovery section of alternative processing point 165. Item 110 may be recovered by sender 105 or recipient 155 upon the completion of a tracer. A tracer is a form completed by sender 105 or recipient 155 to locate delayed or undelivered items. While item recovery may occur at alternative processing point 165, those skilled in the art will appreciate that may other types of processing may be performed at alternative processing point 165.

While resolving system 185 is shown to be separate from delivery system 130, the functionality of resolving system 185 may be performed under the control of the delivery system operator at alternative processing point 165, at any point within delivery system 130, or at any point outside delivery system 130. Moreover, the functionality of resolving system 185 may be performed by an enterprise not under the control of the delivery system operator.

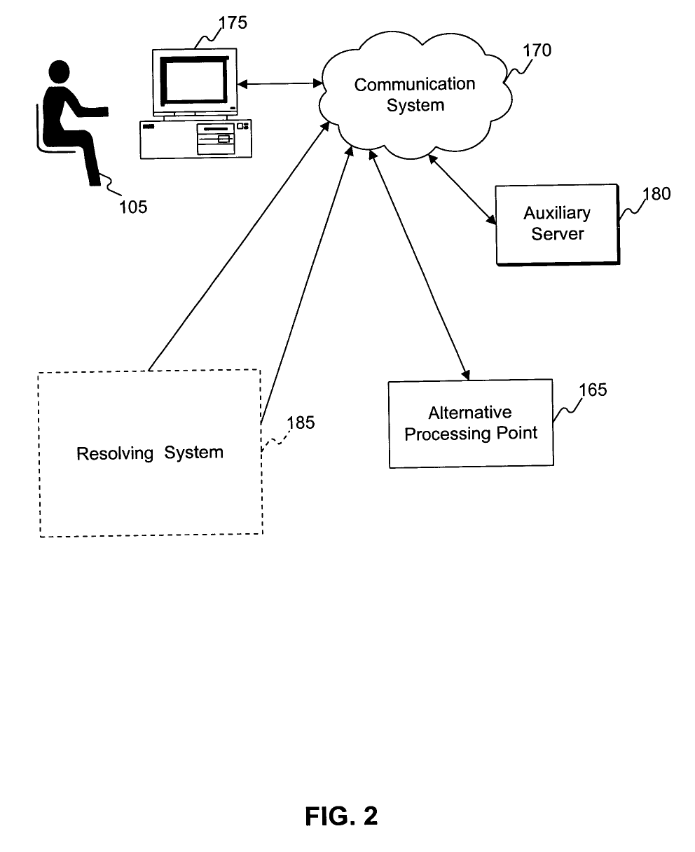

As herein embodied and illustrated in FIG. 2, elements of system 100 comprising user device 175, communication system 170, and resolving system 185 will be described in greater detail. User device 175 may comprise a personal computer or other similar microcomputer-based workstation. It can be appreciated, however, that user device 175 may comprise any type of computer operating environment such as hand-held devices, multiprocessor systems, microprocessor-based or programmable sender electronics, minicomputers, mainframe computers, and the like. User device 175 may also be practiced in distributed computing environments where tasks are performed by remote processing devices. Furthermore, user device 175 may comprise a mobile terminal such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and user device 175 may comprise other systems or devices.

A PDA is a handheld computer that serves as an organizer for personal information. It generally includes at least a name and address database, to-do list and note taker. PDAs are typically pen-based and use a stylus (“pen”) to tap selections on menus and to enter printed characters. The unit may also include a small on-screen keyboard which is tapped with the pen. Data may be synchronized between the PDA and a desktop computer through a cable or wireless transmissions.

WAP is a standard for providing cellular phones, pagers and other handheld devices with secure access to e-mail and text-based Web pages. It provides a complete environment for wireless applications that includes a wireless counterpart of TCP/IP and a framework for telephony integration such as call control and phone book access. Wireless Markup Language (WML), which is a streamlined version of HTML for small screen displays, is featured in WAP. WAP uses WMLScript, a compact language that runs in limited memory, and supports handheld input methods such as keypads and voice recognition. In addition, WAP is independent of the air interface and runs over all the major wireless networks. Moreover, it is also device independent, requiring only a minimum functionality in the unit so that it can be used with many different phones and handheld devices.

User device 175 may be located in a home, office, store, an item delivery counter within a store, a retail center kiosk, an item delivery system office, or any location wherein it may be operated. Moreover, user device 175 may be operated by sender 105 that may comprise a subject, a technician, an advisor, a sales consultant, a sales person, or any other person. It can be appreciated that user device 175 may be located at a variety of places and operated by a variety of people.

Communication system 170 may comprise, for example, a local area network (LAN) or a wide area network (WAN). Such networking environments are commonplace in offices, enterprise-wide computer networks, intranets, and the Internet, and are known by those skilled in the art. When a LAN is used as communication system 170, user device 175 and elements of resolving system 185 may be connected to communication system 170 through a network interface located at each of the respective user device 175 and elements of resolving system 185. When a WAN networking environment is utilized as communication system 170, user device 175 and elements of resolving system 185 typically include an internal or external modem (not shown) or other means for establishing communications over the WAN, such as the Internet.

In addition to utilizing a wire line communications system as communication system 170, a wireless communications system, or a combination of wire line and wireless may be utilized as communication system 170 in order to, for example, exchange web pages via the internet, exchange e-mails via the Internet, or for utilizing other communications channels. Wireless can be defined as radio transmission via the airwaves, however, those skilled in the art will appreciate that various other communication techniques can be used to provide wireless transmission including infrared line of sight, cellular, microwave, satellite, packet radio and spread spectrum radio. User device 175 and elements of resolving system 185 in the wireless environment can be any mobile terminal such as a cellular phone, personal digital assistant (PDA), intelligent pager, portable computer, hand held computer, or any device capable of receiving wireless data. Wireless data may include, but is not limited to, paging, text messaging, e-mail, Internet access and other specialized data applications specifically excluding or including voice transmission.

In utilizing communication system 170, data sent over communication system 170 may be encrypted to insure data security. When encrypting, the data may be converted into a secret code for transmission over a public network. The original file, or “plaintext,” may be converted into a coded equivalent called “ciphertext” via an encryption algorithm executed, for example, on user device 175 or on elements of resolving system 185. The ciphertext is decoded (decrypted) at a receiving end and turned back into plaintext.

The encryption algorithm may use a key, which is a binary number that is typically from 40 to 128 bits in length. The greater the number of bits in the key (cipher strength), the more possible key combinations and the longer it would take to break the code. The data is encrypted, or “locked,” by combining the bits in the key mathematically with the data bits. At the receiving end, the key is used to “unlock” the code and restore the original data.

There are two main cryptographic methods that may be suitable for use with system 100. The traditional method uses a secret key, such as the Data Encryption Standard (DES). In DES, both sender and receiver use the same key to encrypt and decrypt. This is the fastest method, but transmitting the secret key to the recipient in the first place is not secure. The second method is public-key cryptography, such as the Rivest-Shamir-Adleman (RSA) highly-secure cryptography method by RSA Data Security, Inc., Redwood City, Calif., (www.rsa.com). RSA uses a two-part concept with both a private and a public key. The private key is kept by the owner; the public key is published. Each recipient has a private key that is kept secret and a public key that is published for everyone. The sender looks up the recipient's public key and uses it to encrypt the message. The recipient uses the private key to decrypt the message. Owners never have a need to transmit their private keys to anyone in order to have their messages decrypted, thus the private keys are not in transit and are not vulnerable.

Public key cryptography software marketed under the name Pretty Good Privacy (PGP) from Pretty Good Privacy, Inc., (PGP) of San Mateo, Calif., (www.pgp.com) may be utilized in this embodiment. PGP was developed by Phil Zimmermann, founder of the company, and it is based on the RSA cryptographic method. A version for personal, non-business use is available on various Internet hosts. While PGP may be used to encrypt data transmitted over communication system 170, those skilled in the art will appreciate that many other types of encryption algorithms, methods and schemes may be employed.

In system 100, data may be transmitted by methods and processes other than, or in combination with communication system 170. These methods and processes may include, but are not limited to, transferring data via, diskette, CD ROM, facsimile, conventional mail, an interactive voice response system (IVR), or via voice over a publicly switched telephone network. An IVR is an automated telephone answering system that responds with a voice menu and allows the user to make choices and enter information via the telephone keypad. IVR systems are widely used in call centers as well as a replacement for human switchboard operators. An IVR system may also integrate database access and fax response.

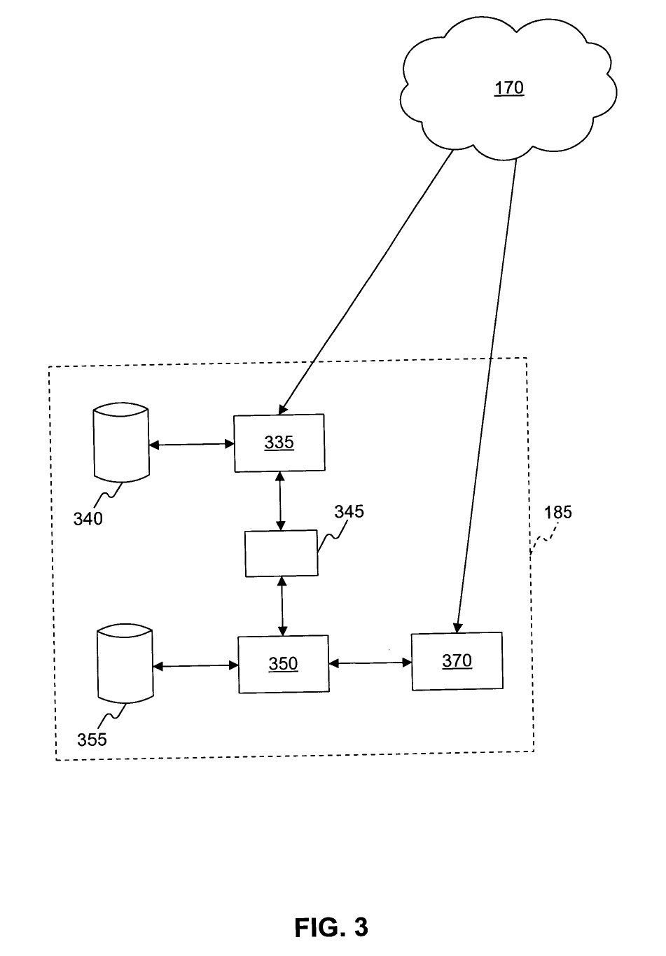

Referring to FIG. 3, exemplary resolving system 185 may comprise a first server front end 335 with its associated first server front end database 340, a first server back end 350 with its associated first server back end database 355, and a simple mail transfer protocol (SMTP) server 370. Those skilled in the art will appreciate that this particular architecture of resolving system 185 is exemplary, and that many other types of systems or architectures may be employed to implement resolving system 185.

In exemplary resolving system 185, first server front end 335 is separated from first server back end 350 by a first server firewall 345. One function of first server front end 335 is to provide an interface via communication system 170 between user device 175 and resolving system 185. The function of the SMTP server 370 is to provide, for example, an e-mail interface via communication system 170 between user device 175 and resolving system 185.

Simple mail transfer protocol is a standard e-mail protocol on the Internet. It is a TCP/IP protocol that defines the message format and the message transfer agent (MTA), which stores and forwards the mail. SMTP was originally designed for only ASCII text, but MIME and other encoding methods enable program and multimedia files to be attached to e-mail messages. SMTP servers route SMTP messages throughout the Internet to a mail server, such as a Post Office Protocol 3 (POP3) or an Internet Messaging Access Protocol (IMAP) server, which provides a message store for incoming mail.

Post Office Protocol 3 (POP3) servers, using the SMTP messaging protocol, are standard mail servers commonly used on the Internet. POP3 servers provide a message store that holds incoming e-mail until users log on and download them. With POP3, all pending messages and attachments are downloaded at the same time. Internet Messaging Access Protocol (IMAP) is also a standard mail server that is widely used on the Internet. It provides a message store that holds incoming e-mail until users log on and download them. IMAP, however, is more sophisticated than the POP3 mail server. In IMAP, messages can be archived in folders, mailboxes can be shared, and a user can access multiple mail servers. There is also better integration with MIME, which is used to attach files. For example, users can read only the headers in the message without having to automatically accept and wait for unwanted attached files to download.

First server front end 335 and first server back end 350 may comprise a personal computer or other similar microcomputer-based workstations. Those skilled in the art, however, will appreciate that first server front end 335 and first server back end 350 may comprise any appropriate type of computer operating environment such as hand-held devices, multiprocessor systems, microprocessor-based or programmable sender electronics, minicomputers, mainframe computers, and the like. First server front end 335 and first Server back end 350 may also be practiced in distributed computing environments where tasks are performed by remote processing devices. Specifically, embodiments of first server front end 335 may utilize a COMPAQ PROLIANT 1600 server running WINDOWS 2000 and DOMINO Webserver. Similarly, first server back end 350 may be implemented on a COMPAQ PROLIANT 1600 server running NT4 and DOMINO Application Server. SMTP server 370 may be implemented on a COMPAQ DL 360 running WINDOWS 2000 and DOMINO SMTP Mail Server.

Other servers, such as an auxiliary server 180 shown in FIG. 2, may be included in system 100. Other servers used in system 100 may be constructed in an architecture similar to resolving system 185 or may be constructed using other suitable architectures as are known by those skilled in the art.

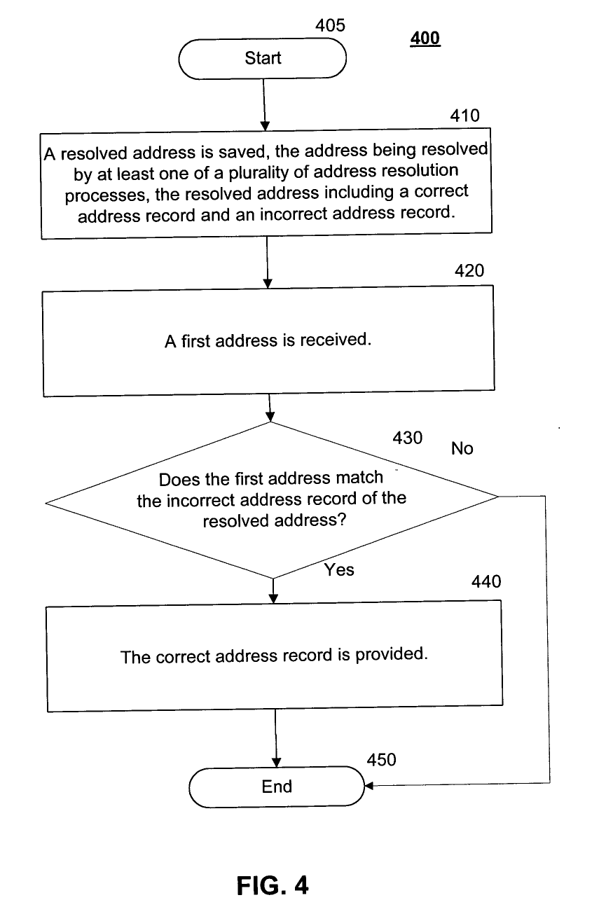

FIG. 4 is a flow chart setting forth the general stages involved in exemplary method 400 for resolving an un-coded address. The implementation of the stages of exemplary method 400 in accordance with an exemplary embodiment of the present invention will be described in greater detail below. Consistent with an embodiment of the invention, address label 115 on item 110 may contain an incorrect or un-coded address. An un-coded address may comprise, for example, an address with an incorrect or missing ZIP code. In this case, the delivery system operator may process data from address label 115 through one of a plurality of address resolution processes in order to obtain a correct address for item 110. However, if data from address label 115 had been previously resolved, a database containing the resolved address including a correct address record and an incorrect record may produce the correct address through a data base query. In this case, the correct address may be produced without having to use one of the plurality of address resolution processes to resolve the address a second time.

Exemplary method 400 begins at starting block 405 and proceeds to stage 410 where a resolved address is saved. The address may be resolved by at least one of a plurality of address resolution processes. The resolved address may include a correct address record and an incorrect address record. For example, the correct address record may comprise a correctly coded address that includes a delivery address that matches information in the ZIP+4 database and is given a valid ZIP with four-digit add-on. ZIP+4 (ZIP defines the USPS's Zone Improvement Program) is a five-digit code for a particular delivery area. The “+4” are add-on digits that indicate, for example, a specific block and side of the block for that ZIP Code. An incorrect address record may comprise an un-coded address that includes a delivery address that does not match information in the ZIP+4 database due, for example, to bad delivery address information. An incorrect address record may also comprise, for example, an address without a ZIP+4 (or 9 digit) code.

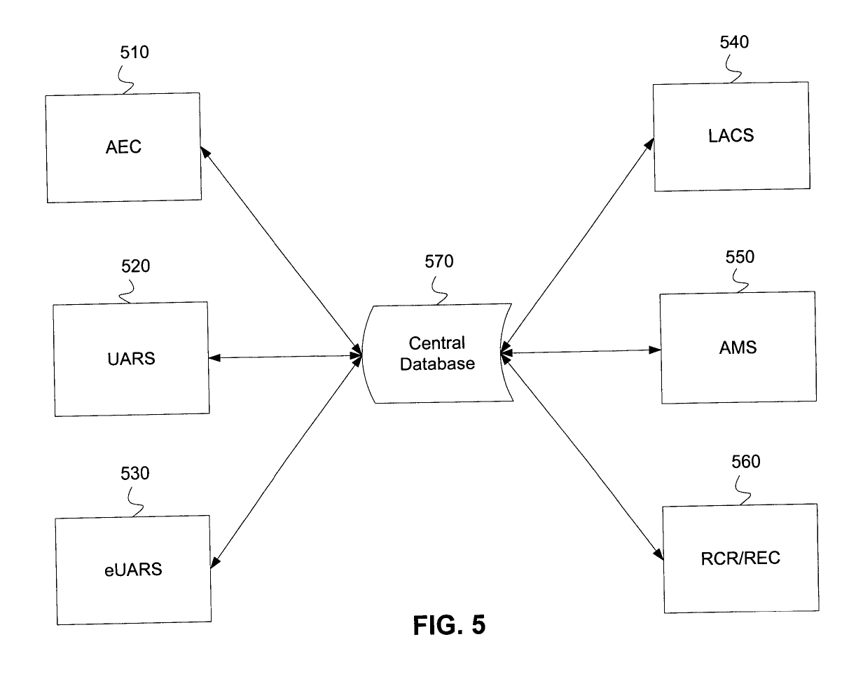

Referring to FIG. 5, the plurality of address resolution processes may comprise a Address Element Correction (AEC) process 510, an Uncorrected Address Resolution System (UARS) 520, an Electronic Uncorrected Address Resolution System (eUARS) 530, a Locatable Address Correction System (LACS) 540, an Address Matching Software (AMS) 550, and a Postal RCR/REC hardware 560. Each of these processes will be described in greater detail below. Any of the aforementioned processes may receive an unresolved address and may produce a resolved address comprising a correct address and an incorrect address to be stored in a database 570. The aforementioned processes and database 570 may be performed manually or within, but are not limited to, resolving system 185. Furthermore, the aforementioned processes are exemplary and other processes may receive an unresolved address and may produce a resolved address.

AEC process 510 may take unresolved addresses and attempt to get a correct ZIP+4 code by evaluating and changing individual address components to see if a match can made. For example, if the address 123 Main Ave is received and a ZIP+4 engine is unable to find a valid ZIP+4, the address could be sent to AEC process 510 to evaluate each of the address components to see if a modification of a component will result in a valid ZIP+4 match. (A ZIP+4 engine may comprise a computer module that returns a proper ZIP+4 code for a given address.) For example, if the suffix is changed to Street rather than Ave, a valid ZIP+4 may be produced. Or if there is no 100 or 200 block in Main Ave, an inverse number process (changing the 123 to 321 or 312) may be used to see if is a valid ZIP+4 match can be made

UARS 520 may comprise a manual system. In this system, items containing addresses that could not be ZIP+4 coded, for example, may be sent out to the post office or other element of delivery system 130 that provides delivery service for the ZIP Code on address label 115. Once at the post office, a mail carrier or other personnel may verify or validate and supply missing or incorrect information.

eUARS 530 is similar to UARS 520. However, in eUARS 530 the un-coded address may be electronically sent to the post office or other element of delivery system 130 that handles the ZIP Code through network 170, for example.

LACS 540 may comprise a process that converts rural addresses (i.e. Rural Route 1, Box 6A) to city-style addresses (1538 W. Hwy 92). Similarly, AMS 550 may convert some common error addresses or vanity addresses to produce a proper ZIP+4, for example.

With RCR/REC 560, mailpieces passing through facilities such as first address plant 140 or alternative address plant 145, for example, which have unreadable addresses are sent to manual keyer stations. Personnel at these stations key the address into a database, comprising a ZIP+4 engine for example, and attempt to extract a valid ZIP+4 address from the database. This manual key process in RCR/REC 560 may be used to correct an OCR mis-read, but can be used for other corrections also.

Referring back to FIG. 4 from stage 410 where the resolved address is saved, exemplary method 400 continues to stage 420 where a first address is received. For example, item 110 may contain an error in address label 115 that makes it undeliverable. For example, the address indicated on address label 115 may not exist. The address is thus considered to be “unresolved.” In such case, the address indicated on address label 115 may be sent to and received by resolving system 185 through network 170. The unresolved address may be sent by the delivery system operator or by any other person or enterprise seeking address resolution.

Once the first address is received in stage 420, exemplary method 400 advances to decision block 430 where it is determined if the first address matches the incorrect address record of the resolved address saved by stage 410 in database 570. For example, the first address may be received by resolving system 185 through network 170. Resolving system 185 may compare the first address with the incorrect address record included with the resolved address stored in database 570. If the first address matches the incorrect address record, then the correct address record included with the resolved address is considered to be a correct version of the first address.

From decision block 430, if it is determined that the first address matches the incorrect address record of the resolved address, exemplary method 400 advances to stage 440 where the correct address record is provided. For example, the resolved address including the correct address record may be sent from resolving system 185 through network 170 to the delivery system operator or by any other person or enterprise seeking address resolution and method 400 ends at stage 450. However, if it was determined at decision block 430 that the first address does not match the incorrect address record of the resolved address, exemplary method 400 ends at stage 450.

It will be appreciated that a system in accordance with an embodiment of the invention can be constructed in whole or in part from special purpose hardware or a general purpose computer system, or any combination thereof. Any portion of such a system may be controlled by a suitable program. Any program may in whole or in part comprise part of or be stored on the system in a conventional manner, or it may in whole or in part be provided in to the system over a network or other mechanism for transferring information in a conventional manner. In addition, it will be appreciated that the system may be operated and/or otherwise controlled by means of information provided by an operator using operator input elements (not shown) which may be connected directly to the system or which may transfer the information to the system over a network or other mechanism for transferring information in a conventional manner.

The foregoing description has been limited to a specific embodiment of this invention. It will be apparent, however, that various variations and modifications may be made to the invention, with the attainment of some or all of the advantages of the invention. It is the object of the appended claims to cover these and such other variations and modifications as come within the true spirit and scope of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

We claim:

1. A method for resolving an un-coded address, comprising:
saving a resolved address, the address being resolved by at least one of a plurality of address resolution processes, the resolved address including a correct address record and an incorrect address record;
receiving a first unresolved address;
determining if the first unresolved address matches the incorrect address record of the resolved address; and
outputting the correct address record if the first address matches the incorrect address record.

2. The method of claim 1, comprising processing the first address if the first address does not match the incorrect address record.

3. The method of claim 2, wherein processing the first address if the first address does not match the incorrect address record comprises using at least one of the plurality of address resolution processes.

4. The method of claim 1, wherein the first address corresponds to an item being processed for delivery in an item delivery system.

5. The method of claim 4, wherein the item delivery system comprises the United States Postal Service.

6. The method of claim 4, wherein the item comprises at least one of a mailpiece, a United States Postal Service Priority Mail package, a United States Postal Service Express Mail Package, a United States Postal Service Global Express Mail Package, and a United States Postal Service Global Express Guarantee Package.

7. The method of claim 1, wherein at least one of the plurality of address resolution processes includes sending an item including the incorrect address record, the item configured to be delivered in an item delivery system, to an element of the item delivery system that delivers in an area defined by a United States Postal Service ZIP code included in the incorrect address record wherein a delivery system operator at least one of verifies, validates, and supplies missing or incorrect information to be included in the correct address record.

8. The method of claim 1, wherein at least one of the plurality of address resolution processes includes entering the incorrect address record into a database to obtain a correct United States Postal Service ZIP+4 code to be included in the correct address record.

9. The method of claim 1, wherein at least one of the plurality of address resolution processes includes modifying individual address components of the incorrect address record to obtain a valid match to a database entry.

10. The method of claim 1, wherein at least one of receiving and providing further comprises utilizing at least one of regular mail, e-mail, facsimile, internet, and an interactive voice response system.

11. The method of claim 1, wherein at least one of receiving and providing further comprises communicating over a network.

12. The method of claim 1, wherein the first unresolved address includes an incorrect United States Postal Service ZIP+4 code.

13. A system for resolving an un-coded address, comprising:
a component for saving a resolved address, the address being resolved by at least one of a plurality of address resolution processes, the resolved address including a correct address record and an incorrect address record;
a component for receiving a first unresolved address;
a component for determining if the first unresolved address matches the incorrect address record of the resolved address; and
a component for providing the correct address record if the first unresolved address matches the incorrect address record.

14. The system of claim 13, comprising a component for processing the first unresolved address if the first unresolved address does not match the incorrect address record.

15. The system of claim 14, wherein the component for processing the first unresolved address if the first unresolved address does not match the incorrect address record is further configured for using at least one of the plurality of address resolution processes.

16. The system of claim 13, wherein the first unresolved address corresponds to an item being processed for delivery in an item delivery system.

17. The system of claim 16, wherein the item delivery system comprises the United States Postal Service.

18. The system of claim 16, wherein the item comprises at least one of a mailpiece, a United States Postal Service Priority Mail package, a United States Postal Service Express Mail Package, a United States Postal Service Global Express Mail Package, and a United States Postal Service Global Express Guarantee Package.

19. The system of claim 13, wherein at least one of the plurality of address resolution processes includes sending an item including the incorrect address record, the item configured to be delivered in an item delivery system, to an element of the item delivery system that delivers in an area defined by a United States Postal Service ZIP code included in the incorrect address record wherein a delivery system operator at least one of verifies, validates, and supplies missing or incorrect information to be included in the correct address record.

20. The system of claim 13, wherein at least one of the plurality of address resolution processes includes entering the incorrect address record into a database to obtain a correct United States Postal Service ZIP+4 code to be included in the correct address record.

21. The system of claim 13, wherein at least one of the plurality of address resolution processes includes modifying individual address components of the incorrect address record to obtain a valid match to a database entry.

22. The system of claim 13, wherein at least one of the component for receiving and the component for providing are further configured for utilizing at least one of regular mail, e-mail, facsimile, internet, and an interactive voice response system.

23. The system of claim 13, wherein at least one of the component for receiving and the component for providing are further configured for communicating over a network.

24. The system of claim 13, wherein the first unresolved address includes an incorrect United States Postal Service ZIP+4 code.

25. A computer-readable medium on which is stored a set of instructions for resolving an un-coded address, which when executed perform stages comprising:
saving a resolved address, the address being resolved by at least one of a plurality of address resolution processes, the resolved address including a correct address record and an incorrect address record;
receiving a first unresolved address;
determining if the first unresolved address matches the incorrect address record of the resolved address; and
outputting the correct address record if the first unresolved address matches the incorrect address record.

26. The computer-readable medium of claim 25, comprising processing the first unresolved address if the first unresolved address does not match the incorrect address record.

27. The computer-readable medium of claim 26, wherein processing the first unresolved address if the first unresolved address does not match the incorrect address record comprises using at least one of the plurality of address resolution processes.

28. The computer-readable medium of claim 25, wherein the first unresolved address corresponds to an item being processed for delivery in an item delivery system.

29. The computer-readable medium of claim 28, wherein the item delivery system comprises the United States Postal Service.

30. The computer-readable medium of claim 28, wherein the item comprises at least one of a mailpiece, a United States Postal Service Priority Mail package, a United States Postal Service Express Mail Package, a United States Postal Service Global Express Mail Package, and a United States Postal Service Global Express Guarantee Package.

31. The computer-readable medium of claim 25, wherein at least one of the plurality of address resolution processes includes sending an item including the incorrect address record, the item configured to be delivered in an item delivery system, to an element of the item delivery system that delivers in an area defined by a United States Postal Service ZIP code included in the incorrect address record wherein a delivery system operator at least one of verifies, validates, and supplies missing or incorrect information to be included in the correct address record.

32. The computer-readable medium of claim 25, wherein at least one of the plurality of address resolution processes includes entering the incorrect address record into a database to obtain a correct United States Postal Service ZIP+4 code to be included in the correct address record.

33. The computer-readable medium of claim 25, wherein at least one of the plurality of address resolution processes includes modifying individual address components of the incorrect address record to a valid match to a database entry.

34. The computer-readable medium of claim 25, wherein at least one of receiving and providing further comprises utilizing at least one of regular mail, e-mail, facsimile, internet, and an interactive voice response system.

35. The computer-readable medium of claim 25, wherein at least one of receiving and providing further comprises communicating over a network.

36. The computer-readable medium of claim 25, wherein the first unresolved address includes an incorrect United States Postal Service ZIP+4 code.

37. A system for resolving an un-coded address, comprising:
means for saving a resolved address, the address being resolved by at least one of a plurality of address resolution processes, the resolved address including a correct address record and an incorrect address record;
means for receiving a first unresolved address;
means for determining if the first unresolved address matches the incorrect address record of the resolved address; and
means for outputting the correct address record if the first unresolved address matches the incorrect address record.

38. The system of claim 37, comprising means for processing the first unresolved address if the first unresolved address does not match the incorrect address record.

39. The system of claim 38, wherein the means for processing the first unresolved address if the first unresolved address does not match the incorrect address record is further configured for using at least one of the plurality of address resolution processes.

40. The system of claim 37, wherein the first unresolved address corresponds to an item being processed for delivery in an item delivery system.

41. The system of claim 40, wherein the item delivery system comprises the United States Postal Service.

42. The system of claim 40, wherein the item comprises at least one of a mailpiece, a United States Postal Service Priority Mail package, a United States Postal Service Express Mail Package, a United States Postal Service Global Express Mail Package, and a United States Postal Service Global Express Guarantee Package.

43. The system of claim 37, wherein at least one of the plurality of address resolution processes includes sending an item including the incorrect address record, the item configured to be delivered in an item delivery system, to an element of the item delivery system that delivers in an area defined by a United States Postal Service ZIP code included in the incorrect address record wherein a delivery system operator at least one of verifies, validates, and supplies missing or incorrect information to be included in the correct address record.

44. The system of claim 37, wherein at least one of the plurality of address resolution processes includes entering the incorrect address record into a database to obtain a correct United States Postal Service ZIP+4 code to be included in the correct address record.

45. The system of claim 37, wherein at least one of the plurality of address resolution processes includes modifying individual address components of the incorrect address record to obtain a valid match to a database entry.

46. The system of claim 37, wherein at least one of the means for receiving and the means for providing are further configured for utilizing at least one of regular mail, e-mail, facsimile, internet, and an interactive voice response system.

47. The system of claim 37, wherein at least one of the means for receiving and the means for providing are further configured for communicating over a network.

48. The system of claim 37, wherein the first unresolved address includes an incorrect United States Postal Service ZIP+4 code.
